(19) United States
(12) Patent Application Publication
(10) Pub. No.: US 2012/0072340 A1
(43) Pub. Date: Mar. 22, 2012

(54) METHODS AND SYSTEMS FOR ESTABLISHING COMMUNICATIONS WITH MOBILE DEVICES

(76) Inventor: Alan Amron, Miami Beach, FL (US)

(21) Appl. No.: 13/158,418

(22) Filed: Jun. 11, 2011

Related U.S. Application Data
(60) Provisional application No. 61/354,018, filed on Jun. 11, 2010.

(51) Int. Cl. H04W 76/02; G06Q 20/38; G06F 15/16

(52) U.S. Cl. 705/39; 709/227; 455/422.1

(57) ABSTRACT

A method comprises determining, at a first communication terminal, that a second communication terminal is at a selected geo-spatial location relative to the first communication terminal and transmitting from the first communication terminal, a broadcast invitation to the second communication terminal to establish a peer-to-peer communication session. At the second communication terminal, a message is displayed prompting acceptance of the transmitted invitation and, responsive to a manipulation of the second terminal indicative of acceptance of the transmitted invitation, launching an executable session management program at the second communication terminal to thereby establish a communication session during which data may be exchanged between the first and second communication terminals. The step of launching includes downloading the session management program into a memory of the second communication terminal if the session management program is not already stored in memory for execution by a processor of the second communication terminal.

### REFERENCE TO RELATED APPLICATIONS

This patent claims the benefit of U.S. provisional patent application Ser. No. 61/354,018 filed on Jun. 11, 2010, which application is hereby incorporated by reference in its entirety.

### BACKGROUND

1. Field of the Invention

The present invention generally relates to network communications and, more particularly, to the exchange of information between two or more communication terminals wherein at least one of the communication terminals is a handheld, electronic device.

2. Discussion of the Background Art

Mobile communication terminals such as cell phones, smart phones, personal data assistants (PDAs), pagers, handheld computers, and laptop computers have become integral tools used in a wide variety of different applications as, for example, in finance and commercial transactions, health care, telecommunication, and education. Such devices have typically been configured to exchange signals on a subscription basis with the base stations of a service provider's network, and to this end they have been configured to utilize the signaling communication protocol(s) (e.g., CDMA, TDMA, and GSM) supported by the service provider.

More recent advances in technology have made it feasible to incorporate significant processing power in even the most compact of portable devices. With such features as expanded memory storage, wireless local area network (WLAN) support, and the ability to simultaneously execute multiple application programs, the mobile communication terminal devices of today have become platforms for social interaction, financial transactions, online shopping and web browsing, and consumption of multimedia content. Peer-to-peer, communication session initiation applications even exist to enable users to consummate financial transactions and exchange multimedia content, text messages, and even voice conversations when their communication terminals are close enough together to transmit and receive information via short range wireless transmission protocols such, for example, as Bluetooth, IEEE 802.11, and iRDA.

A deficiency of known applications for establishing communication sessions between two or more communication terminals addressable as endpoints of a wireless network, however, is that no session can be initiated between them unless the initiating terminal already possesses the identification information needed to address the other terminal(s). For example, to initiate a call or send a text using subscription services offered by a carrier's network, the user of a mobile device has heretofore been required to know the telephone number of the targeted mobile device. Alternatively, to initiate a communication session without accessing the carrier network, each communication terminals must heretofore have been configured, a priori, to receive, recognize and accept invitations from the other, as well as to set up whatever communication link which will be used to facilitate the exchange of information between the two terminals.

An example of a proximity-based solution initiating communications sessions between two communication terminals is disclosed in UK Patent Application GB 2483453 filed by Carter on May 5, 2006 and entitled “PROXIMITY BASED MOBILE CHAT”. The inventor states that no base station signal is required and all communication is peer-to-peer, so that no chat server is required. Users are anonymous and are identified only by a photo and a registered pseudonym. The mobile communication terminal of each participating user is configured to execute a peer-to-peer chat application that causes the terminal to display a list of other participating users whose terminals are near enough for chat sessions to be undertaken over a short range wireless link such, for example, as Bluetooth, IEEE802.11, and iRDA.

Another example of a proximity-based system for initiating communication sessions between communication terminals is disclosed in UK Patent Application GB 2457257 filed by Adamson et al. on Feb. 6, 2008 and entitled “Contact-less Financial Transactions Using Mobile Devices”. The solution disclosed by Adamson et al. relies upon the availability of an open-standards based application that has already been distributed to users of first and second mobile communication terminals, respectively. The user of the first terminal, wishing to tender payment, and the user of the second terminal, wishing to accept payment, each invoke the application to establish a peer-to-peer connection (via Bluetooth or other open wireless link protocol) and exchange sufficient information to consummate the transaction.

Characteristic of the prior art, the systems disclosed by Carter and Adamson et al depend upon the prior distribution of an application program that is executable by the device processor of each device to discover the proximity of a peer device and to initiate and establish the communication session between them. Disadvantageously, such arrangements do not permit a communication terminal user to set up a communication session with the user of a communication terminal not already configured to execute the application program.

A continuing need therefore exists for a system and method by which communication sessions can be initiated between communication terminals, even when at least one of the communication terminals is a mobile communication terminal and where neither communication terminal has acquired specific network address information corresponding to other.

A further need exists for a system and method wherein a first communication terminal may optionally initiate a communication session with a second communication terminal based upon a selected geo-spatial relationship between the first and second communication terminals.

Yet another need exists for a system and method of initiating a communication session between two communication terminals, in proximity to one another, which does not require the addition of new file or message types, or the introduction of new transmission protocols.

### SUMMARY

The aforementioned needs are addressed, and an advance is made in the art, by a systems and methods for initiating a communication session—which session may encompass a voice conversation, an exchange of text messages, delivery of information relating to special sales promotions such, for example, as electronic coupons, or an exchange of data needed to consummate a financial transaction—with or among one or more mobile communication terminals such as cell phones, smart phones, personal data assistants (PDAs), pagers, handheld computers, phone-enabled laptop computers, and other mobile electronic devices and, more particularly, to systems and methods employing a geo-spatial, peer-to-peer discovery approach to the initiation of such communication sessions.

In accordance with a first embodiment of the present invention, a session initiation management program executed by the processor of a first communication terminal is invoked, when a second communication terminal is at a selected geo-spatial location relative to the first communication terminal, to transmit an invitation to establish a peer-to-peer communication. To this end, the transceiver of the first communication terminal is operative under the control of a processor executing the session management program to emit a wireless signal that is not omnidirectional but, rather, focused or directed in such a way as to have a high likelihood of reaching only the second communication terminal. At the second communication terminal, a message is displayed prompting acceptance of the transmitted invitation. By way of illustrative example, the invitation transmitted by the first communication terminal is formatted as—and is processed by the second communication terminal as, a Short Message Service (SMS) or a Multimedia Messaging Service (MMS) message.

Although it is intended by the inventor herein that a user of the first communication terminal may “target” an invitation message at the second communication terminal by the aforementioned focused transmission, it should be understood that the invitation message is also “broadcast” in the sense that the first communication terminal is presumed to lack access to a network address or other unique identifier associated with the second communication terminal. By transmitting the invitation message in the aforementioned SMS or MMS format, the user of the second communication terminal is able to receive, recognize and process the message and, if desired, exchange such information as may be necessary to establish the subsequent peer-to-peer communication session. As for the wireless transmission protocol utilized by the first communication terminal to transmit the invitation message, this admits of substantial flexibility. For exemplary purposes, the signal may take the form of a Bluetooth, IEEE 802.11, conventional infrared, or iRDC transmission.

Responsive to manipulation of the second terminal indicative of acceptance of the transmitted invitation (e.g. depression of a hard or soft “accept” key), an instance of the executable session management program at the second communication terminal is executed by the processor of the second communication terminal, whereupon the second and first communication terminals exchange sufficient information to establish a communication session. The step of executing is preceded by a step of downloading the session management program into a memory of the second communication terminal if the session management program is not already stored therein. This downloading may be achieved either via a peer-to-peer file transfer operation initiated by the session management program or a URL address may be specified in the invitation message whereby the session management program may be downloaded via the carrier network.

In accordance with an exemplary embodiment of the present invention, execution of the session initiation management program by the first and second mobile communication terminals establishes a peer-to-peer voice communication session in which packetized voice data is exchanged between them, whereby the conversation takes place without the need for either terminal to utilize the infrastructure of the carrier network. As will be readily apparent to one skilled in the art, the terminals need not utilize the same wireless protocol to carry out the communication session as was used to transmit the invitation message.

In accordance with another exemplary embodiment of the present invention, execution of the session initiation management program by the first and second mobile communication terminals establishes a peer-to-peer text chat session. By way of yet another exemplary embodiment, the execution of the session initiation management program by the first and second mobile communication terminals facilitates an e-commerce transaction in which a form of electronic payment is offered by the user of the first communication terminal and accepted by the user of the second communication terminal.

In accordance with yet another embodiment of the present invention, one of the communication terminals is configured as a broadcast node able to direct invitation messages to a plurality of mobile communication terminals with a radius defined by the transmission capabilities of the wireless protocol used and the characteristics of the channel path. As in the previously described embodiments, use of a ubiquitous message format such, for example, as the SMS or MMS formats, allows the targeting communication terminals to receive and process invitation message in a manner identical to that described above. Utilizing a topology constructed in accordance with this embodiment, it is possible for a session management server to deliver advertisements, promotional offers, coupons and the like to any mobile communication terminal near enough to one of its broadcast nodes to receive and process the invitation message.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block schematic diagram depicting two mobile communication terminals in which an embodiment of the invention is implemented; and

FIG. 2 is a flow chart illustrating the steps of initiating and establishing a communication session between the two communication terminals depicted in FIG. 1, in accordance with an exemplary embodiment of the present invention; and

### DETAILED DESCRIPTION

Reference will now be made in detail to the preferred embodiments of the present invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described detail as not to unnecessarily obscure aspects of the present invention.

Some portions of the detailed descriptions which follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. In the present application, a procedure, logic block, process, etc., is conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proved convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “generating”, “canceling”, “assigning”, “receiving”, “forwarding”, “dumping”, “updating”, “bypassing”, “transmitting”, “determining”, “retrieving”, “displaying”, “identifying”, “modifying”, “processing”, “preventing”, “using” or the like, refer to the actions and processes of an electronic system or a computer system, or other electronic computing device/system such as a personal digital assistant (PDA), a cellular phone, a pager, etc. The computer system or similar electronic computing device manipulates and transforms data represented as physical (electronic) quantities within the computer system's registers and memories into other data similarly represented as physical quantities within the computer system memories or registers or other such information storage, transmission, or display devices. The present invention is also well suited to the use of other computer systems such as, for example, optical and mechanical computers.

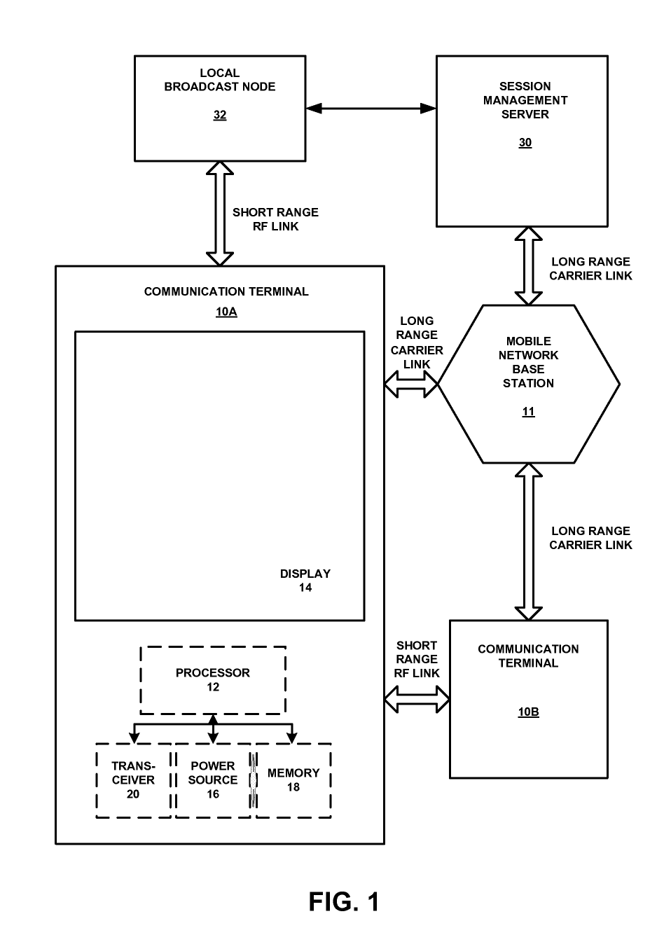

Turning now to FIG. 1, there are shown schematically two illustrative communication terminals, indicated generally at 10a and 10b, which may be adapted to initiate and establish communication sessions in accordance with the teachings of the present invention. By way of illustrative example, communication terminals 10a and 10b may be mobile communication terminals (e.g., smart phones) adapted to exchange long range RF signals with the base stations as base station 11 of a carrier network via well known signaling protocol such, for example, as CDMA, TDMA or GDM. With particular reference to communication. To that end, each communication terminal as terminal 10a includes a processor 12 coupled to a display 14, a power source 16, a memory 18, and one or more transceivers as transceiver 20 for transmitting and receiving signals as, for example, via the carrier network.

In accordance with an exemplary embodiment of the present invention, an application program is stored within memory 18 for implementing the various functions needed for terminal 10a to function as a conventional smartphone. A transceiver of terminal 10a is also configured to transmit and receive signals compliant with at least one wireless protocol such, for example, as Bluetooth, WiFi, iRDC (infrared). As will be readily appreciated by those skilled in the art, a first transceiver as transceiver 20 may be utilized for the exchange of long-range wireless signals with the base stations of a carrier network, while one or more additional transceivers (not shown) may be utilized for the exchange of short range wireless signals needed to establish a peer-to-peer communication session between nearby communication terminals (e.g., from one to one hundred meters apart).

In accordance with an illustrative embodiment of the present invention, there is stored in the memory 18 of terminal 10a a session initiation management (“SIM”) application program that is executable by processor 12 to initiate a peer-to-peer communication session with a second communication terminal as terminal 10b. In the interest of forming session initiation invitations which have a high probability of being received and understood by a wide variety of communication terminals, and especially mobile communication terminals, the invitation message transmitted by terminal 10a is preferably formatted as a Short Message Service (SMS) or a Multimedia Messaging Service (MMS) message.

The user of a communication terminal as communication terminal 10a is preferably presented with the ability to direct an invitation to participate—in a peer-to-peer communication session—to the user of a second communication terminal 10b while the latter is at a selectable geo-spatial location relative to the first communication terminal. As used herein, the phrase “geo-spatial location” is intended to encompass the relationship in physical, three-dimensional space between the first and second communication terminals. In situations where the respective communication terminals are mobile devices such as smart phones, personal digital assistants, and the like, such the relationship includes at least the physical distance between the two terminals (which should be sufficiently close to permit the transmission and reception of the short range wireless signal used to relay an invitation message from, for example, first communication terminal 10A to second communication terminal 10B), and may further include the angle of inclination of, say, terminal 10B relative to terminal 10B. It is further contemplated that GPS or presence server location services may be made available by the carrier network to communication terminals 10A and 10B. In such cases, the geo-spatial relationship may be derived from such information to obtain the free-space positions of each communication terminal relative to one or more fixed reference points and/or to each other.

In any event and with continued reference to FIG. 1, it will be appreciated that a variety of techniques may be employed to allow the first communication terminal to select the second communication terminal for an exchange of information in accordance with the teachings of the present invention. By way of illustrative example, where both communication terminals 10A and 10B are mobile devices, the selection may be made merely by physically aiming or “pointing” the first mobile device at the second mobile device (or the user carrying it, of course) to thereby “fix” a selected geo-spatial location. The determination as to whether a mobile device is pointing to another device may be made as the result of the directional nature of the transceiver (as transceiver 20 of terminal 10A). For example, a mobile device may be deemed as pointing to another device if using direction transmitters/receivers, the targeted device receives a signal from the targeting device. Transmitters may also be used similarly to determine the direction of the transmitter based on characteristics of the transmission signal that vary with direction, such as signal strength. Similarly, a mobile device may include a scanner, such as a camera (not shown) that can be used to determine that a particular target device is in its line of sight This may be accomplished by using a camera associated with the targeting device to scan a bar code or other code on the targeting device.

The determination as to whether a mobile communication terminal is pointed to a targeted mobile communication terminal may also be made using components that return the direction or azimuth that the mobile communication terminal is pointing in, and/or the location of the targeting mobile communication terminal and targeted mobile communication terminal. For example, the communication terminal 10A may include a compass or magnetometer (not shown) that determines the magnetic bearing of transceiver 20. Terminal 10A may also include a GPS component (not shown) that returns the location of communication terminal 10A at a given time.

As noted above, in determining that communication terminal 10A is being pointed, terminal 10A may also take into account its angle of inclination. By way of example, terminal 10A may include an orientation sensor or accelerometer (not shown) that returns the inclination of terminal 10A, which in turn indicates that terminal 10A is being pointed in a likely direction of another communication terminal (as, for example, terminal 10B), as opposed to being used for any other purpose. Such an accelerometer may also be used to determine whether the user is performing a pointing gesture with terminal 10A (e.g., moving the device abruptly in a likely direction of another terminal).

In operation a user of communication terminal 10A wishing to establish a communication session with a user of communication terminal 10B simply points terminal 10A in the direction of terminal 10B. As noted previously, the act of pointing terminal 10A may be determined using an accelerometer and/or a compass as a trigger for the session initiation management (SIM) application program that will at least attempt to initiate communication with terminal 10B. The SIM application program that establishes this link may be configured for execution without any other user intervention or initiation. That is, an instance of the SIM program stored by terminals 10A and/or 10B may be launched and run in the background merely by energizing each such device. This will ensure that both terminal 10A and 10B are ready to communicate when terminal 10A is pointed in the direction of 10B. The SIM application itself may run as part of the operating system of at least terminal 10A, as an add-on application that is executed at startup automatically, or as an add-on application that is invoked by the user of terminals 10A or 10B immediate before an invitation message to initiate a communication session is sent (as in the case of targeting a terminal) and immediately after receipt of an invitation to initiate a communication session (as in the case of a targeted terminal.

It is further contemplated that a targeted device as terminal 10B may not already be running the SIM application. To this end, at terminal 10B a message is displayed prompting acceptance of the transmitted invitation. By way of illustrative example, the invitation transmitted by the first communication terminal is formatted as—and is processed by the second communication terminal as, a Short Message Service (SMS) or a Multimedia Messaging Service (MMS) message. In a conventional manner, an SMS or MMS message may be used to invoke launching and execution of the SIM application by the processor of terminal 10B—without further user intervention if the SIM application were already present. However, in the event such application it is not already present, the user is instead presented with a visual prompt to either accept the communication session—at which point the application is downloaded—either directly from an initiating terminal as terminal 10A via a short range wireless protocol or from a remote server via, for example, the carrier network—and subsequently launched.

Although it is intended by the inventor herein that a user of terminal 10A may “target” an invitation message at another communication terminal by a focused transmission of a wireless signal, it should be understood that the invitation message is also “broadcast” in the sense that communication terminal is presumed to lack access to a network address or other unique identifier associated with the second communication terminal. By transmitting the invitation message in a ubiquitous, universally accepted format such as SMS or MMS, the user of terminal 10B is able to receive, recognize and process the message and, if desired, exchange such information as may be necessary to establish the subsequent peer-to-peer communication session. As for the wireless transmission protocol utilized by the first communication terminal to transmit the invitation message, this admits of substantial flexibility. For exemplary purposes, the signal may take the form of a Bluetooth, IEEE 802.11, conventional infrared, or iRDC transmission.

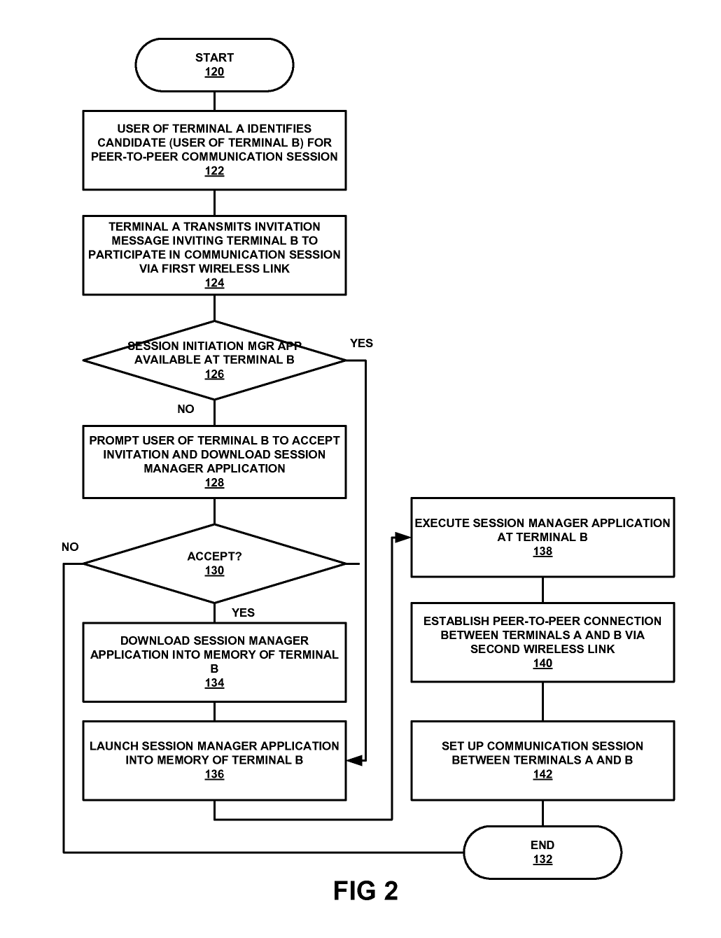

With reference now to FIG. 2, there is shown in accordance with an illustrative embodiment of the present invention, a process for initiating a peer-to-peer communication session between two communication terminals, at least one of which is a mobile communication terminal such as a cell phone, smart phone, or personal digital assistant. The process is entered at block 120, whereupon at block 122 a user of terminal A identifies the user of terminal B as an entity with which the user would like to transact a communication session. At block 124, terminal A transmits an invitation message inviting terminal B to participate in a communication session via first wireless link 124.

At decision block 126, if the session manager application is not already present and available for execution at terminal B, the process passes to block 128 whereupon the user is prompted to accept the invitation to participate in the transmission session and informed that the application must first download. If the user of terminal A accepts (decision block 130), the process proceeds to block 134 whereupon the session management application is downloaded to terminal B. Once the application finishes downloading, or if it was already determined to be present at block 126, the process proceeds to launching and execution of the session management program (blocks 136 and 138, respectively. Thereafter, the process proceeds to the establishing of a peer-to-peer connection (block 140) between terminals A and B via suitable wireless link (which may be, for example, an 802.11 link, a Bluetooth link or any link possessing suitable qualities for the type and rate of data to be exchanged during the communication session, and the communication session thereafter proceeds (block 142) by continued execution of the SIM program. When the session is finished, or if the user of terminal B declines the invitation at block 130, the process terminates at block 132.

What is claimed:

1. A method for establishing a communication session between a first communication terminal and a second communication terminal, wherein at least one of the first and second communication terminals is a mobile communication device, said method comprising the steps of:
executing at the first communication terminal, a stored session management program executable by a processor of the first communication terminal to support an exchange of data between the first and second communication terminals via a wireless, peer-to-peer connection;
transmitting over a first wireless link, from the first communication terminal, a broadcast invitation message to the second communication terminal to establish a peer-to-peer communication session while the second terminal is at a selected geo-spatial location;
displaying, at the second communication terminal, a message prompting a user of the second communication terminal to accept the invitation transmitted during said step of transmitting; and
responsive to acceptance of the invitation by the user of the second communication terminal, launching the executable session management program at the second communication terminal to thereby establish a communication session over a second wireless link during which data may be exchanged between the first and second communication terminals, said step of launching including downloading the session management program into a memory of the second communication terminal if the session management program is not already stored in memory for execution by a processor of the second communication terminal.

2. The method of claim 1, wherein the first wireless link utilized during said step of transmitting is one of an infrared and a Bluetooth wireless link.

3. The method of claim 2, wherein the wireless, peer-to-peer connection established by execution of the session management program utilizes one of a Bluetooth and an IEEE 802.11 transmission protocol.

4. The method of claim 1, wherein the first and second communication terminals are both mobile communication devices, said method further including a step of determining whether the second communication terminal is at the selected geo-spatial location while a user of the first communication terminal points the first communication terminal at a user carrying the second communication terminal.

5. The method of claim 4, wherein the step of determining is based upon at least one characteristic of a signal, transmitted by the second communication terminal, which varies with the geo-spatial orientation of the first communication terminal relative to the second communication terminal.

6. The method of claim 5, wherein the at least one characteristic is signal strength.

7. The method of claim 4, wherein the determining step includes a step of monitoring signal transmission activity by communication terminals close enough to exchange signals with the first communication terminal over a short-range wireless link and a step of displaying, to the user of the first communication terminal, a representation of the geo-spatial relationship of at least some of said plurality of communication terminals relative to the first communication terminal, whereby the user of the first communication terminal may select the second communication terminal from among said plurality of communication terminals prior to the step of transmitting.

8. The method of claim 4, wherein the session management program is executable to Initiate and maintain a peer-to-peer voice telephone call between the first communication terminal and the second communication terminal.

9. The method of claim 4, wherein the session management program is executable to initiate and maintain a peer-to-peer exchange of text messages between the first communication terminal and the second communication terminal.

10. The method of claim 4, wherein said step of transmitting an invitation comprises transmitting a broadcast SMS message via a short range wireless protocol to the second communication terminal.

11. The method of claim 1, wherein said step of transmitting an invitation comprises transmitting a broadcast SMS message via a short range wireless protocol to the second communication terminal.

12. The method of claim 1, wherein the session management program is executable to initiate and consummate a financial transaction, whereby the user of the second communication terminal tenders an electronic payment to one of a user and an establishment associated with the first communication terminal.

13. The method of claim 1, further including a step of determining whether the second communication terminal is at the selected geo-spatial location while a user of the first communication terminal points the first communication terminal at a user carrying the second communication terminal.

14. The method of claim 1, further including:
executing, at the first communication terminal, the stored session management program to support an exchange of data between the first communication terminal and a third communication terminal via a wireless, peer-to-peer connection;
transmitting over a third wireless link from the first communication terminal, an invitation message to the third communication terminal to establish a peer-to-peer communication session while the third terminal is at a selected geo-spatial location;
displaying, at the third communication terminal, a message prompting a user of the third communication terminal to accept an invitation transmitted during said step of transmitting; and
responsive to acceptance of the invitation by the user of the third communication terminal, launching the executable session management program at the third communication terminal to thereby establish a communication session over fourth communication link during which data may be exchanged between the first and third communication terminals, said step of launching including downloading the session management program into a memory of the third communication terminal.

15. The method of claim 14, wherein the session management program is executable to initiate and conduct a financial transaction, whereby the user of the third communication terminal tenders an electronic payment to an establishment associated with the first communication terminal.
